(19) United States
(12) Patent Application Publication
(10) Pub. No.: US 2019/0164120 A1
(43) Pub. Date: May 30, 2019

(54) Article Quality Management System and Article Quality Management Method

(71) Applicant: HITACHI, LTD., Tokyo (JP)

(72) Inventors: Tomotoshi ISHIDA, Tokyo (JP); Yuya TOKUDA, Tokyo (JP); Kohhei AIDA, Tokyo (JP)

(73) Assignee: Hitachi, Ltd., Tokyo (JP)

(21) Appl. No.: 16/097,721

(22) PCT Filed: Mar. 6, 2017
(86) PCT No.: PCT/JP2017/008713

§ 371 Date: Oct. 30, 2018

(30) Foreign Application Priority Data
May 16, 2016 (JP) 2016-097526

(51) Int. Cl. G06Q 10/08

(52) U.S. Cl. CPC G06Q 10/0832; G06K 19/06037; G06Q 10/0838

(57) ABSTRACT

The present invention provides a system and method by which the quality of a plurality of articles having the same management code assigned can be managed while in distribution. Input devices receive input of data of management codes of articles at distribution sites of the articles, and transmit to a management device the management code data, the date and time at which the management code data has been inputted, and data of the input site. the management device: drives, for all combinations of management codes and the input sites among the data which has been transmitted from the input devices, lead data having the earliest input date and time; compares the input dates and times of the lead data for all combinations of any two different input sites, for each of the management codes among all of the management codes; treats article distribution routes from the input site having a late input date and time to the input site having a nearly input date and time as being non-existent; and derives, as candidates for article distribution routes, the combinations other than those for which no distribution route exists from among all combinations of any two different input sites.

### TECHNICAL FIELD

The present invention relates to a system and a method for managing the quality of a plurality of articles distributed through a plurality of distribution channels.

### BACKGROUND ART

Some articles transported from a site of manufacture to a site of consumption by way of a plurality of distribution channels require appropriate management with respect to environmental conditions including temperature, humidity, vibration, gas, atmospheric pressure, and the like. For example, some foods, when placed in a high-temperature or low-temperature environment, are made unsuitable for consumption due to rotting or souring. Some foods are deteriorated in quality when placed in a high-humidity environment or an environment involving an atmospheric level of oxygen. Some articles are destroyed when vibration is applied beyond an assumed maximum level.

In some cases, a forged article may be blended into articles in a distribution channel.

To cope with these problems, when transporting or storing articles, management measures are taken, including packaging of the articles in a gastight enclosure, temperature and humidity management using an air conditioner of a transport container, a transport truck, and a storage chamber, vibration management through vibration measurement, or the like. However, there are cases where the environmental conditions surrounding an article get out of a management range (preferred environmental condition) due to mechanical failure, overlooking under management, or the like.

When a problem of the environmental conditions surrounding an article getting out of a management range arises, a measure may be taken to assist in identifying a cause or a site of occurrence of the problem: management codes are given to articles, the management codes of articles handled at a plurality of sites or by a plurality of dealers are inputted to a management system and the data thereof is analyzed. The management code is inputted to a management system at a plurality of spots (locations) on distribution channels along which articles are manufactured, transported, and sold.

Patent Literature 1 discloses a system in which a barcode reader with a temperature measuring apparatus is utilized to detect management data and an article temperature as well at a plurality of points on a distribution channel and these pieces of data are transmitted to a management device. Thus, the histories of articles can be checked. This system uses a combination of barcodes and temperature indicating patterns varying in color according to temperature.

### CITATION LIST

### Patent Literature

Patent Literature 1: Japanese Unexamined Patent Application Publication No. 2002-87542

### SUMMARY OF INVENTION

### Technical Problem

Some of a plurality of articles transported and distributed are individually given a different management code and others are given an identical management code on a group-by-group basis.

In the case of the former, all the pieces of data pertaining to an identical management code are collected and arranged in the order of input time. As a result, these pieces of data are arranged in the order of distribution and time-series variation in environmental condition can be grasped with respect to one article. When any data out of a management range is found, it can be estimated that such an event (problem) that the environmental conditions surrounding the article get out of the management range occurred between a spot where data was inputted at an input time immediately preceding the input time of the problematic data and a spot where the data out of the management range was inputted.

In the case of the latter, however, an identical management code is given to a plurality of articles. Therefore, when the articles are distributed on different distribution channels, a site of occurrence of the problem cannot be identified even when the pieces of data of management code are sorted in time order. As a result, the quality of distributed articles may be not appropriately managed. In more detail, a spot subsequent to a site of occurrence of a problem can be identified but a spot preceding a site of occurrence of a problem cannot be identified sometimes.

The system described in Patent Literature 1 is applicable only to the former case, that is, cases where a unique management code is given to each article. It is difficult to apply the system to the latter case, that is, cases where an identical management code is given to a plurality of articles.

If a forged article is blended into articles on a distribution channel, it would be required to immediately grasp a location where the forged article was blended to remove the forged article or take a like measure to manage the quality of the distributed articles. If a distribution channel of an article is unknown, it would be difficult to follow up already distributed articles even when the environmental conditions surrounding an article get out of a management range or a forged article is blended into articles on a distribution channel. As a result, it is difficult to manage the quality of articles while in distribution.

In consideration of the foregoing, the present invention has been made. It is an object of the present invention to provide a system and a method in which the quality of a plurality of articles given an identical management code can be appropriately managed while in distribution.

### Solution to Problem

An article quality management system according to the present invention is characterized in that the system includes: an input device for receiving an input of data on the management codes of a plurality of distributed articles from the articles; a management device having a computation unit and a storage unit and receiving and recording data transmitted form the input device; and an output device displaying data outputted by the management device. The articles are classified into a plurality of groups according to the management codes and the articles belonging to an identical one of the groups are marked with an identical one of the management codes. The input device receives an input of data on the management codes at a plurality of sites through which the articles are distributed and transmits data on the management codes inputted and data on a date and time of input and a site of input of the data on the management codes to the management device. The management device obtains earliest data, which is data for which the date and time of input are earliest, with respect to all the combinations of the management codes and the sites of input in a plurality of pieces of data transmitted from the input device. With respect to the earliest data, the management device then compares the date and time of input with the earliest data with respect to all the combinations of two different sites of input for each of all the management codes. The management device performs distribution channel estimation processing based on the fact that there is not a distribution channel of the articles running from a site of input with the later date and time of input toward a site of input with the earlier date and time of input. The management device obtains, among all the combinations of the two different sites of input, a combination other than the combinations for which it is determined by the estimation processing that there is not a distribution channel as a candidate for a distribution channel of the articles. The output device displays the candidate for the distribution channel of the articles.

### Advantageous Effects of Invention

According to the present invention, it is possible to provide a system and a method in which the quality of a plurality of articles given an identical management code can be appropriately managed while in distribution.

### BRIEF DESCRIPTION OF DRAWINGS

FIG. 1A is a drawing illustrating an example of an article bearing a two-dimensional barcode and an environmental-responsive portion.

FIG. 1B is a drawing illustrating an example of an article bearing a one-dimensional barcode and an environmental-responsive portion.

FIG. 2 is a drawing schematically illustrating distribution channels of articles.

FIG. 3 is a drawing illustrating data on distribution channels of articles in the form of table.

FIG. 4 is a drawing schematically illustrating distribution channels of articles, showing a case where distribution channels differ depending on timing or the types of articles.

FIG. 5 is a drawing illustrating data on distribution channels of articles changed according to timing or the types of articles in the form of table.

FIG. 6 is a drawing illustrating a part of data such as management code inputted at each location and transmitted to a management device in the form of table.

FIG. 7 is a drawing illustrating steps of processing performed by a management device in a first embodiment.

FIG. 8 is a table obtained by summarizing the numbers of pieces of the data shown in FIG. 6 by location and by management code.

FIG. 9 is a drawing illustrating steps of processing performed by a management device in a third embodiment.

FIG. 10 is a drawing showing date and time data inputted at the earliest date and time with respect to each location and each management code shown in FIG. 6 in the form of table.

FIG. 11A is a table indicating a possibility of presence of a distribution channel between two locations and is a table at the initial stage of generating the data shown in FIG. 11D.

FIG. 11B is a table showing a result of examination on whether a distribution channel is present between two locations with respect to articles of management code L1738.

FIG. 11C is a table showing a result of examination on whether a distribution channel is present between two locations with respect to articles of management code L1745.

FIG. 11D is a table showing a result of examination on whether a distribution channel is present between two locations with respect to articles of management code L1738 and articles of management code L1745.

FIG. 12 is a drawing schematically illustrating a configuration of an article quality management system according to the first embodiment of the present invention.

FIG. 13 is a table indicating whether a distribution channel is present between two locations, generated from the table in FIG. 3.

### DESCRIPTION OF EMBODIMENTS

An article quality management system according to the present invention manages the environmental conditions for a plurality of articles managed by a method generally referred to as lot management or type management, that is, a plurality of articles given an identical management code, on a distribution channel. A more specific description will be given. Data on management codes inputted at a plurality of spots on distribution channels of articles and data on the distribution channels are utilized to manage the environmental conditions surrounding the articles. When any anomaly occurs in the environmental conditions surrounding the articles, it is possible to estimate a time and a spot at which the anomaly has probably occurred. When distribution channels are changed depending on the distribution timing of articles or the type of articles, it is also possible to take it into account in management of the environmental conditions surrounding the articles.

A plurality of articles distributed through a plurality of distribution channels are classified into a plurality of groups according to management codes. A plurality of articles belonging to an identical group are marked with an identical management code.

When there is no data on a distribution channel of an article, an article quality management system according to the present invention is capable of generating data on a candidate for a distribution channel of an article from data on an inputted management code and data on the date and time of input and the spot of input for the management code.

When a forged article is blended into articles on a distribution channel, an article quality management system according to the present invention makes it possible to easily estimate the timing and spot of the blend.

Hereafter, a description will be given to implementations of an article quality management system and an article quality management method according to the present invention with reference to the drawings. A management code of an article cited here refers to a number for identifying the article and is given to the article during manufacture or on other like occasions. The management code makes it possible to identify the model, type, timing of manufacture, site of manufacture, and the like of an article. There are cases where a different management code is given to each article and cases where an identical number is given to a plurality of articles by article model or by lot based on site of manufacture, date and time of manufacture, or the like. The present invention is applied mainly to the latter cases.

Hereafter, the environmental conditions surrounding an article getting out of a management range (preferred environmental conditions) will be referred to as “environmental deviation” and an article whose surrounding environmental conditions are out of a management range will be referred to as “environmentally deviated article.”

### First Embodiment

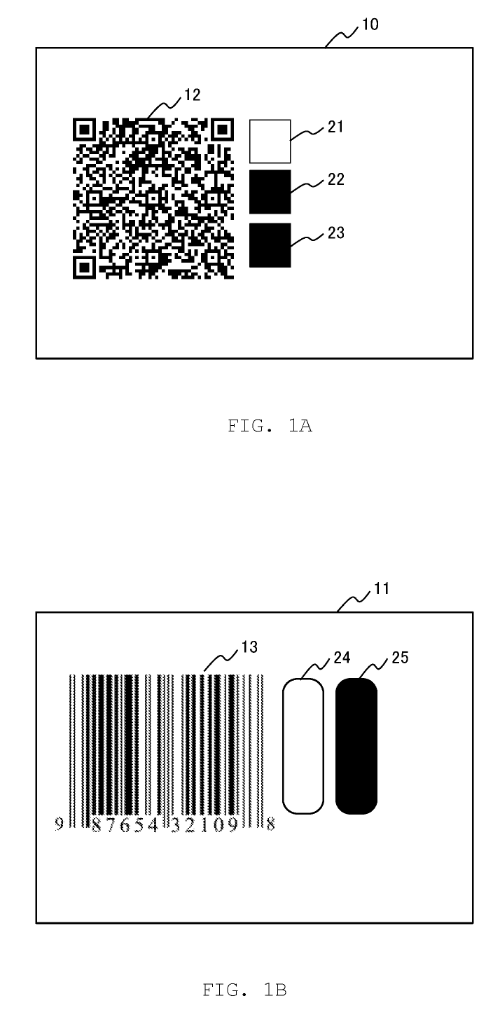

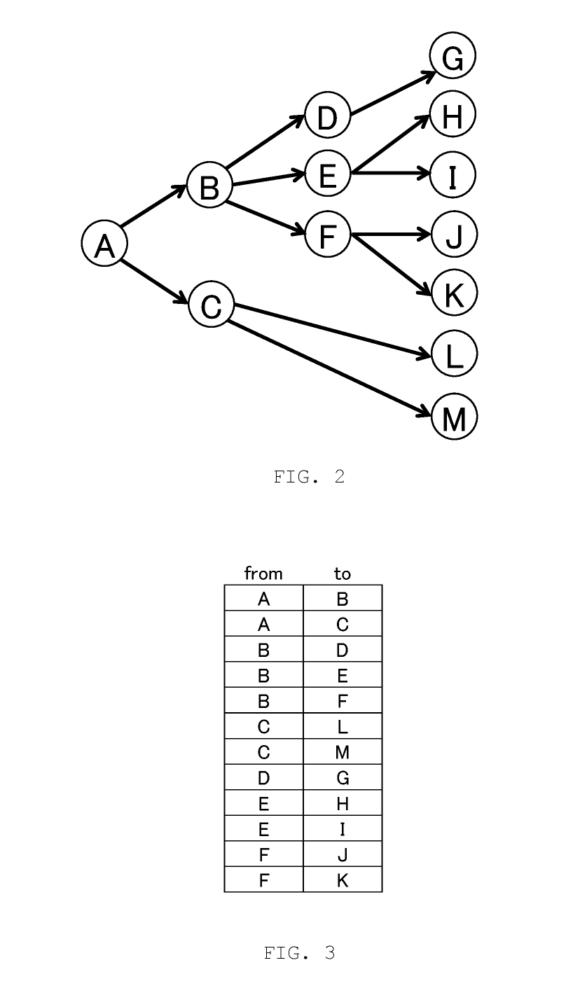

FIG. 1A and FIG. 1B illustrate examples of articles bearing a barcode and an environmental-responsive portion. The article 10 shown in FIG. 1A is marked with a typical two-dimensional barcode 12 and environmental-responsive portions 21, 22, 23. The article 11 shown in FIG. 1B is marked with a typical one-dimensional barcode 13 and environmental-responsive portions 24, 25.

The barcodes 12, 13 represent a management code of each article expressed by a character string of numeric characters, alphabetic characters, or the like by a barcode pattern. Note that the barcodes 12, 13 shown in FIG. 1A and FIG. 1B do not represent a character string for an actual management code used in the present invention. Though aside from a dimensional difference, there are various standards for barcodes, the present invention does not depend on those standards. Though various types of transform processing are used to pattern a character string, the present invention does not depend on those transform processing methods.

In cases where a management code represented by a barcode identifies only the model of each article, a symbol indicating a lot number or a site of manufacture may be given to each article in the ordinary form of characters. In such cases, a combination of a management code represented by a barcode and a lot number or the like represented by ordinary characters can be newly handled as a management code. Thus, the same processing as in cases where a barcode representing a management code for distinguishing each lot is used can be performed. Similarly, in cases where a symbol indicating a date and time of manufacture, a consumption time limit, or the like is given to each article in the ordinary form of characters. In such cases, a combination of such a symbol and a management code represented by a barcode can be handled as a new management code. Thus, the same processing as in cases where a barcode representing a management code for distinguishing each lot is used can be again performed. In this description, a case where a management code is represented by a barcode has been taken as an example of a preferred implementation but all the management codes may be represented in the ordinary form of characters.

The environmental-responsive portions 21 to 25 are portions printed in ink whose color is varied depending on the environmental conditions surrounding an article such as temperature, humidity, vibration, gas, atmospheric pressure, and the like. The environmental conditions surrounding an article are indicated by displayed colors. There is no limitation on the environmental-responsive portion for position within an article, shape, size, number of pieces, or the like. However, it is desirable to read a displayed color (color data) as image data together with a barcode. For position, for example, it is desirable to dispose an environmental-responsive portion in proximity to a barcode. For shape, there is no special limitation and any shape, including a square, a rectangle, a circle, an oval, a rectangle with rounded corners, and the like, is acceptable. For size, an environmental-responsive portion is preferably larger than each bar or dot of a barcode and may be so sized that it can be visually recognized with ease.

When a plurality of environmental-responsive portions different in color varying condition are provided on an article, a plurality of environmental conditions can be simultaneously grasped. For example, a plurality of environmental-responsive portions whose color varies at different temperatures can be provided or an environmental-responsive portion whose color varies depending on temperature may be provided together with an environmental-responsive portion whose color varies depending on humidity. A plurality of environmental-responsive portions may be identical or may be different in shape or size.

In cases where a one-dimensional barcode 13 is used, a reading device for barcodes may read pieces of data linearly arranged. For this reason, to read color data from the environmental-responsive portions 24, 25 with a reading device at the same time as the barcode, it is desirable to take the following measure as shown in FIG. 1B: the environmental-responsive portions 24, 25 are linearly shaped, the length thereof is made substantially equal to the bar length of the barcode 13, the environmental-responsive portions are disposed in the same direction as the bars of the barcode 13 are. However, in the present invention, the mode of the one-dimensional barcode 13 is not limited to the foregoing.

The barcodes 12, 13 and the environmental-responsive portions 21 to 25 may be printed directly on the articles 10, 11 or may be printed on a seal or the like, which is then stuck to articles. Character strings representing a management code may be printed in proximity to the barcode 12, 13 in the ordinary form of characters. It is also desirable that an explanation of a relation between displayed colors (color data) and the environmental conditions surrounding the article should be added to the environmental-responsive portions 21 to 25 in the ordinary form of characters or the like.

Data indicating the presence or absence, a number, type, position, or the like of environmental-responsive portions can be included in a character string represented by a barcode. These pieces of data can be easily read with a reading device for barcodes without fail. However, the present invention is not limited to this method. One of preferable methods is that: data on the presence or absence, a number, type, position, or the like of environmental-responsive portions is included in a character string represented by a barcode in addition to a management code or the like. For example, this data is expressed like “1234567;count=3;temperature 10,1.2,0.1;temperature 20,1.2,0.2;moisture,1.2,0.3.” In this example, “1234567” is a management code representing the relevant article. “count=3” indicates that there are three types of environmental-responsive portions. When an environmental-responsive portion is not present, a marking of “count=0” may be provided or portions other than the management code may be not displayed at all. “temperature 10,1.2,0.1” indicates that an environmental-responsive portion varying at a temperature of 10 degrees is present in a position of 1.2 in a horizontal direction and 0.1 in a vertical direction. Though a position can also be expressed as an actual distance (unit: mm or the like) from an arbitrary reference point, it is desirable to express it as a relative position utilizing the dimensions of a barcode. In the case of FIG. 1A, for example, a coordinate system is established in which the vertex at the upper left of the two-dimensional barcode 12 is taken as the origin, the vertex at the upper right is taken as 1 in the horizontal direction, and the vertex at the lower left is taken as 1 in the vertical direction. The position of the center of each environmental-responsive portion 21 to 23 is expressed by this coordinate system. With use of this method, color data can be read from an environmental-responsive portion no matter what position the environmental-responsive portion is disposed.

Data on a barcode and an environmental-responsive portion provided on an article, described up to this point, is read with a reading device based on operation of personal handing that article at each stage, such as manufacture, transport, sales, and the like. Even when data on management code, lot number, date and time of manufacture, consumption time limit, or the like is displayed in the ordinary form of characters, the data can be read with a reading device by adopting a reading device capable of recognizing the characters. Color data from an environmental-responsive portion can also be read as image data with a reading device. In addition, a method of manually inputting data displayed in the ordinary form of characters using a keyboard also falls within the scope of the present invention.

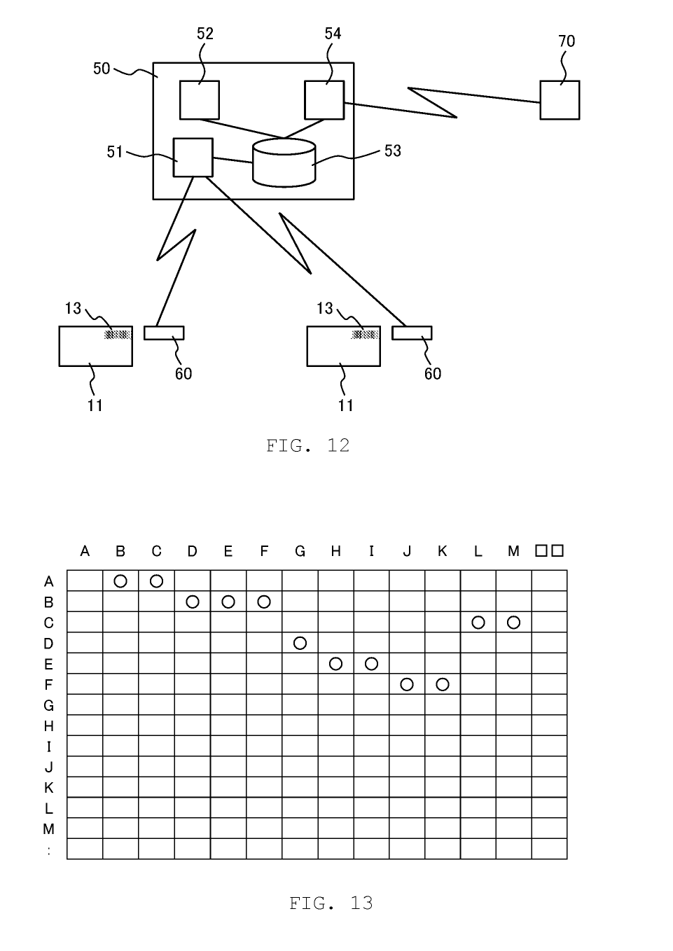

FIG. 12 schematically illustrates a configuration of an article quality management system according to the first embodiment of the present invention. The article quality management system in this embodiment includes a management device 50, an input device 60, and an output device 70. Also, in the embodiments, described later, other than the first embodiment, an article quality management system has the same configuration as in the first embodiment.

The management device 50 includes a data reception unit 51, a computation unit 52, a data output unit 54, and a data storage unit 53 and is comprised of a common computer. The data reception unit 51 receives data transmitted from an input device 60 and stores the data in the data storage unit 53 of the management device 50. The computation unit 52 performs computation processing in the management device 50 and records data on a result of the computation in the data storage unit 53. The data output unit 54 transmits data recorded in the data storage unit 53 to the output device 70.

Each input device 60 receives an input of data on a management code displayed on each article 10, 11 and color data from an environmental-responsive portion and transmits the inputted data to the management device 50. The input device 60 receives an input of data on a management code displayed on an article 10, 11 and color data from an environmental-responsive portion in a plurality of places through which the article 10, 11 is distributed. For the input device 60, a reading device (for example, barcode reader) capable of reading barcodes 12, 13 and further reading color data from environmental-responsive portions 21 to 25 as an image data can be adopted. When data displayed in the ordinary form of characters is manually inputted, a keyboard may be used for the input device 60.

The output device 70 displays on a screen data outputted by the management device 50, that is, data obtained by the management device 50 and data inputted via each input device 60.

Each input device 60 transmits to the management device 50 data on a management code inputted from each article 10, 11 and color data from an environmental-responsive portion. At this time, the input device 60 may receive an input of identification data on an operator of the input device 60, identification data on the input device 60, data on date and time of input and site of input as well and transmit these pieces of data to the management device 50. Thus, the management device 50 can utilize these pieces of data in various analyses later. For data on a site of input, the name and address of the site of input may be used but latitude and longitude may be used instead. Especially, in cases where a point of sale is varied as in cases where articles are sold in a mobile manner, it is desirable to use data in such a form that the data is geographically easy to handle, such as latitude and longitude. The input device 60 receives the abovementioned data at a plurality of spots on distribution channels of articles. The management device 50 records in the data storage unit 53 data transmitted from respective input devices 60 at a plurality of spots (sites of input).

The management device 50 is capable of examining whether the environmental conditions surrounding an article are out of an initially assumed range using data transmitted from each input device 60 on the conditions of date and time, place, management code, identification data on the input device 60, and the like. A result of examination can be displayed on the output device 70 in the form of list, graph, map, or the like. A list is capable of indicating detailed measurement data and showing summary values on a condition-by-condition basis. A summary value can also be indicated in the form of graph. The vertical axis and horizontal axis of each graph can indicate a value varying depending on environmental condition (for example, temperature and humidity), date and time, place, the classification of each article, a number of pieces of data, and the like. Data on site of input can be utilized to plot dots on places on a map satisfying a specific condition by a number of pieces of data. This makes it possible to indicate a geographical distribution of the pieces of data satisfying the specific condition. By analyzing results of these examinations, much information can be acquired about the environmental conditions surrounding an article beyond an initially assumed level and can be used to assist in improvement of a quality management method for each article.

An ink whose color never returns to an original color thereof once changed can be used for environmental-responsive portions. Thus, even when the environmental conditions surrounding an article are once changed and then regained on a distribution channel, it is possible to grasp the environmental conditions surrounding the article present at the time of the change. If the color of ink gradually changes so that a neutral tint is developed (that is, over a plurality of phases), change in the environmental conditions surrounding an article could be minutely grasped.

Each input device 60 may hold data on a relation between color data from an environmental-responsive portion and the environmental conditions surrounding an article in advance. In this case, the input device 60 is capable of determining the acceptability of article quality management (that is, presence or absence environmental deviation) when receiving an input of color data without transmitting data to the management device 50. When a negative determination is made (that is, when an environmental deviation has occurred), it is possible to display a warning or sound an alarm. Further, a reference value may be included in a character string represented by a barcode 12, 13. Thus, this reference value can also be used to determine the acceptability of article quality management.

In cases where temperature is detected as an environmental condition surrounding an article, for example, the following conventionally used materials can be used for the environmental-responsive portion: an inorganic thermochromic material comprised of metallic complex salt such as CoCl₂; an organic thermochromic material comprised of a substituted fused aromatic ring such as a spiropyran-based compound; and the like. Any change in the ambient temperature of an article can be detected from variation in the color of an environmental-responsive portion. There are two types of color variation: reversible and irreversible. In reversible color variation, a color is varied any number of times according to temperature rise or fall; and in irreversible color variation, a color is not returned to an original state thereof once the color is varied at a specific temperature. In the case of irreversible color variation, for example, it is ensured that an ink whose viscosity varies depending on temperature penetrates a penetrable material. Thus, it is possible to, when exposed to a temperature equal to or higher than a set temperature for a certain period of time, let the ink penetrate the penetrable material and cause a variation in color. The present invention is not limited to the type or configuration of these materials or penetrable materials and any material can be used for an environmental-responsive portion as long as the material varies in color according to a temperature change.

FIG. 2 schematically illustrates distribution channels of articles. In FIG. 2, nodes A to M represent such spots (locations) as a site of manufacture, a distribution center, a dealer, or the like and arrows represent transportation routes for articles between nodes. In FIG. 2, node A represents a location of manufacture for manufacturing articles and nodes G to M represent dealers. At nodes A to M, or locations, the input device 60 receives an input of data on a management code or the like of handled articles and transmits the data to the management device 50. It is desirable that each input device 60 should be a reading device such as a barcode reader but the present invention is not limited to such a reading device.

At a location of manufacture represented as node A, articles of a single model or a plurality of models are manufactured and data on a management code representing a model, a manufacturing lot number, a date and time of manufacture, a consumption time limit, and the like as well as an environmental-responsive portion is marked on each article. At this time, it will be assumed that an identical management code is given to a plurality of articles. At the location of manufacture, correspondence between articles and management codes is grasped; therefore, data on management code or the like may be not inputted from articles at an input device 60 and may be transmitted directly to the management device 50 via a communication device provided at the location of manufacture. In this case, it is desirable to use data on the date and time of manufacture of the relevant article or date and time of data transmission instead of date and time of input; however, any other date and time, such as shipping date and time of articles, may be used instead.

The locations represented as nodes B to F are positioned between the location of manufacture and the dealers and equivalent to a distribution center, a distribution warehouse, a wholesale house, or the like. At each of these locations, the input device 60 only has to receive an input of data on a management code or the like at an arbitrary point of time from arrival to shipping of articles at that location and transmit the data to the management device 50. When data input and transmission are performed at a plurality of times during a period of storage of articles from arrival to shipping, it is possible to more minutely grasp the status of the articles in storage.

At each of the dealers represented as nodes G to M, as at each of the locations represented as nodes B to F, the input device 60 only has to receive an input of data on a management code or the like at an arbitrary point of time from arrival to shipping of articles at that dealer and transmit the data to the management device 50.

In an area between a location and a location represented as nodes A to M, a plurality of articles may be put into a single packing box and work such as transportation may be conducted on a box-by-box basis. For articles handled on a box-by-box basis, the same management code as on the articles may be marked on each packing box as well and the input device 60 may receive an input of the management code marked on the packing box and transmit resulting data to the management device 50. In this case, it is desirable to place only articles having an identical management code in one box. It is desirable that the input device 60 should receive an input of a number of articles placed in one box together with a management code or the like and transmit resulting data to the management device 50.

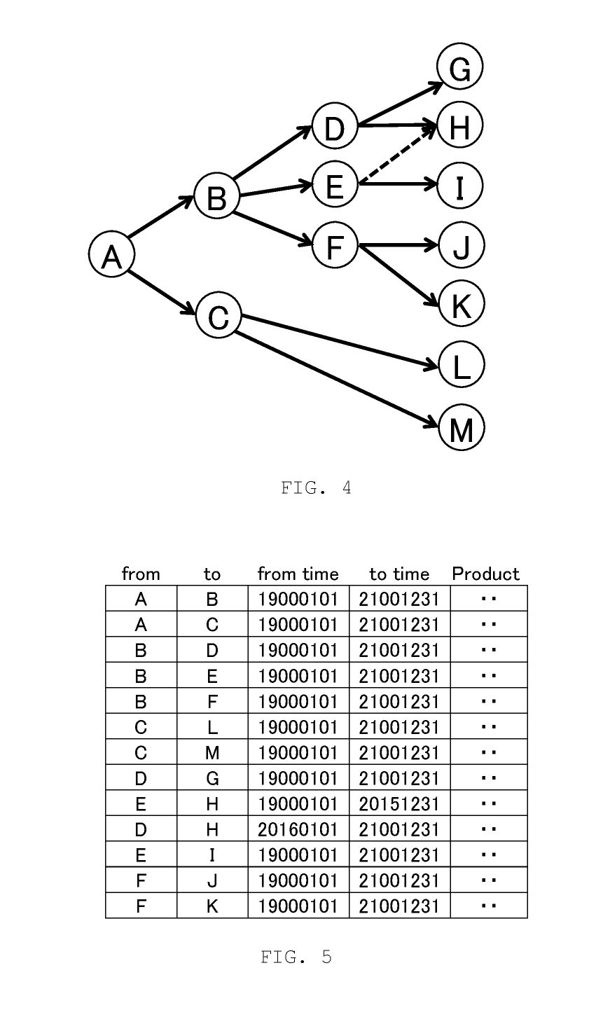

FIG. 3 indicates data on the distribution channels of articles shown in FIG. 2 in the form of table. Data on the distribution channels of articles can be expressed, for example, by the method indicated in FIG. 3. In the table in FIG. 3, the “from” column indicates the location (node) of each transport origin of articles and the “to” column indicates the location of each transport destination of the articles. That is, the “from” column indicates the adjacent location upstream of a location listed in the “to” column on a distribution channel and the “to” column indicates the adjacent location downstream of a location listed in the “from” column on a distribution channel. In FIG. 3, the location of a transport destination and the location of a transport origin corresponding to that location are shown in an identical row.

When any environmentally deviated article is found at any location other than the location of manufacture (location A), the location (findlocation) where this article was found is searched for from the “to” column in the table in FIG. 3. Thus, it can be estimated that an environmental deviation has occurred between the location in the “from” column in a row the “to” column of which includes the findlocation and the findlocation. It will be assumed that the findlocation is, for example, location F. In this case, since location B is in the “from” column in a row the “to” column of which includes location F, it can be estimated that an environmental deviation has occurred between location B and location F. Thus, the management device 50 determines between which two locations an environmental deviation has occurred and outputs data on the determined two locations to the output device 70 together with data on the relevant environmentally deviated article. The output device 70 displays these pieces of data.

When an article involving an environmental deviation or a suspected environmental deviation is found at any plurality of locations other than the location of manufacture (location A), a plurality of masters (upstream locations) of a plurality of the locations (findlocations) where the article was found are searched for in FIG. 2. Thus, it is possible to estimate a location where a reason that caused the environmental deviation is probably present. In the case of an obvious environmental deviation, a cause can be found at the immediately downstream location. In the case of an environmental deviation barely clearing a criterion, there is a possibility that a cause thereof is not found at midway locations. When an article involving a suspected environmental deviation is found at location H and location J in FIG. 2, for example, it can be estimated that a cause thereof is present at location B, a common mater thereof, or upstream thereof. Thus, the management device 50 determines a location involving a suspected environmental deviation and outputs data on the determined location and a relevant channel to the output device 70 together with data on the environmentally deviated article. The output device 70 displays these pieces of data.

FIG. 4 schematically indicates distribution channels of articles like FIG. 2 and shows a case where a distribution channel is varied depending on timing or the type of articles. In the case of a distribution channel shown in FIG. 4, articles had been initially transported from location E to location H as the corresponding distribution channel in FIG. 2 and the distribution channel of the articles was changed so as to transport the articles from location D to location H at some point of time.

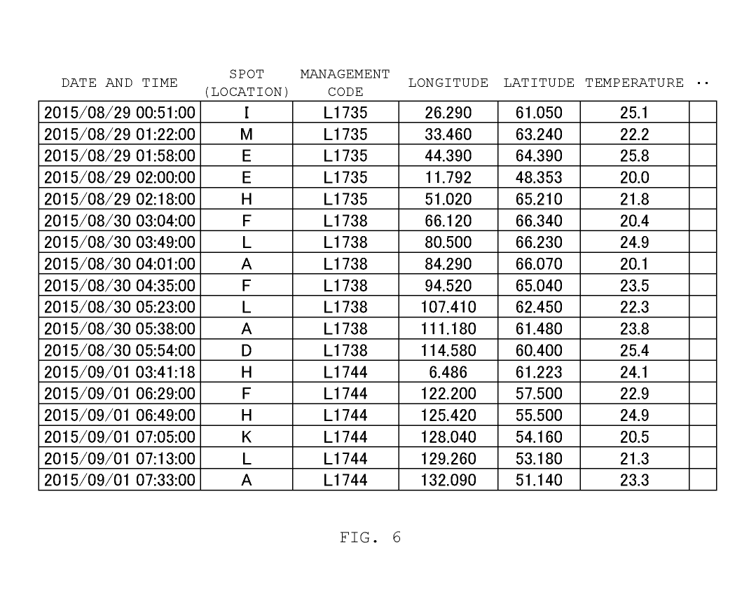

FIG. 5 indicates data on the distribution channels of articles varied depending on timing or the type of articles in the form of table. FIG. 5 is obtained by adding a “from time” column, a “to time” column, and a “Product” column to the table shown in FIG. 3.

First, a description will be given to a case where distribution channels of articles are varied depending on timing. In FIG. 5, the “from time” column indicates a start of a period of time for which data in each row is effective and the “to time” column indicates an end of that period of time. For example, the “from time” column and the “to time” column indicate that data in a row representing transport from location E to location H is effective from Jan. 1, 1900 to Dec. 31, 2015 and that data in a row representing transport from location D to location H is effective from Jan. 1, 2016 to Dec. 31, 2100.

When an environmentally deviated article is found at location H, a findlocation is searched for from the “to” column in the table. When the date and time of finding is before Jan. 1, 2016, it can be estimated that an environmental deviation occurred between location E and location H. When the date and time of finding is after Jan. 1, 2016, it can be estimated that an environmental deviation occurred between location D and location H. Thus, the management device 50 determines between which two locations an environmental deviation has occurred according to the date and time of finding and outputs data on the determined two locations to the output device 70 together with data on the environmentally deviated article. The output device 70 displays these pieces of data.

A description will be given to a case where distribution channels of articles are varied depending on the type of articles. In this case, the management codes of articles are intended to distinguish at least the type of each article and the Product column in FIG. 5 indicates data representing the types of articles obtained from management codes. When a findlocation where an environmentally deviated article was found is searched for from the “to” column in the table, data in the “Product” column is utilized, data in which the type of articles in the “Product” column agrees with the type of the environmentally deviated article is only searched for. It is desirable that data enabling the type of articles to be distinguished should be recorded in the “Product” but the management code of those articles may be recorded.

FIG. 6 indicates a part of data on management codes and the like inputted at each location A to M and transmitted to the management device 50 in the form of table. As shown in FIG. 6, each location may be represented by the name and address of the location or may be represented by the longitude and latitude thereof. However, when a location is represented by an indication other than name, it is desirable to convert the indication other than name into a name-like symbol to represent a location for the sake of usability in subsequent processing (for example, when it is determined whether locations are identical or different).

The “date and time” column indicates a date and time at which the management code or the like of an article is inputted to an input device 60.

The “location” column indicates the name of a location where the management code or the like of an article is inputted and transmitted to the management device 50. The address of a location may be entered into the “location” column.

The “management code” column indicates each management code given to articles at the time of manufacture or on other like occasions and each management code is marked on each article in the form of barcode, character strings, or the like. It is assumed that an identical management code is given to a plurality of articles.

The “longitude” column and the “latitude” column indicate the longitude and latitude of each location listed in the “location” column.

The “temperature” column indicates a temperature as an environmental condition surrounding an article measured when an input device 60 receives an input of management code. The temperature data can be obtained from color data from an environmental-responsive portion marked on an article inputted when an input device 60 receives an input of management code. In the example shown in FIG. 6, temperature is adopted as an environmental condition surrounding an article but humidity, atmospheric pressure, vibration, or the like may be adopted as an environmental condition surrounding an article depending on purposes. Utilization of color data from an environmental-responsive portion may be omitted depending on purposes.

It is desirable that the data shown in FIG. 6 inputted at each location should be read in a lump with a reading device as an input device 60 at that location and be transmitted to the management device 50. However, the data may be read by any other means and transmitted to the management device 50.

The management device 50 receives data transmitted from each input device 60, performs the processing described later, and retrieves effective information from the received data and analyzes the information.

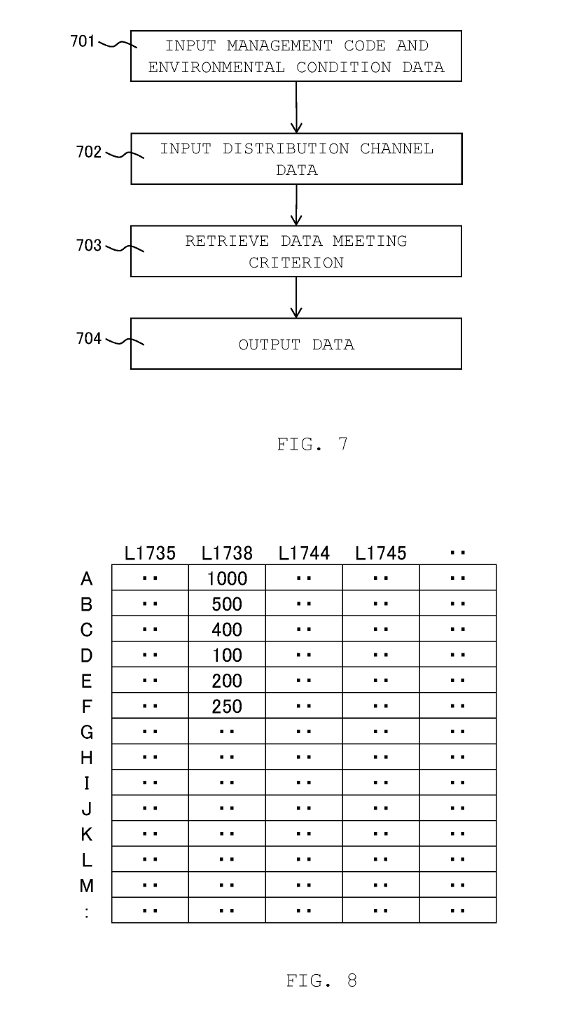

FIG. 7 illustrates steps of processing performed by the management device 50 in this embodiment. The processing shown in FIG. 7 is performed mainly by the computation unit 52.

At Step 701, the management device 50 receives data on a management code of each article, environmental conditions (for example, temperature) surrounding the article, and the like, transmitted from each input device 60, via the data reception unit 51 and records the received data in the data storage unit 53. The management device 50 receives pieces of data transmitted from a plurality of locations one by one, integrates these pieces of data into a set of pieces of data, and records each data set. However, the present invention is not limited to this data recording scheme. The data storage unit 53 records data, for example, in the format shown in FIG. 6.

At Step 702, the management device 50 receives an input of article distribution channel data and records the data in the data storage unit 53. The article distribution channel data is expressed in such a format as shown in FIG. 3 or FIG. 5. The distribution channel data is predetermined data and can be inputted to the management device 50 by using a keyboard or reading a file in which distribution channel data is recorded.

Either of Step 701 or Step 702 may come first.

At Step 703, the management device 50 retrieves data in which an environmental condition (for example, temperature) surrounding an article satisfies a specific criterion from the data (such data as shown in FIG. 6 inputted at each location) recorded in the data storage unit 53 at Step 701. The management device 50 determines that data in which an environmental condition satisfying a specific criterion is data about an environmentally deviated article. This specific criterion for environmental conditions can be arbitrarily specified according to each article and may be specified and set in the management device 50 in advance or may be inputted to the management device 50 before or during execution of the processing of Step 703. Thus, the management device 50 searches for an environmentally deviated article using data (FIG. 6) inputted at each location.

The management device 50 can determine between which two locations an environmental deviation has occurred by combining a date and time, a location, and a management code included in data in which an environmental condition surrounding an article satisfies a specific criterion (that is, data indicating that an environmental deviation has occurred in the article) with article distribution channel data shown in FIG. 3 or FIG. 5. The concrete procedure for this processing is as already described above.

A typical example of the processing of Step 703 is as follows: an upper limit value for temperature is preset as a specific criterion for environmental conditions; data in which the temperature surrounding an article is above the preset upper limit value is searched for; and a location at which the temperature surrounding an article is above the preset upper limit value is found. This processing is applicable to a wide variety of articles, such as frozen food and refrigerated food, distributed under a predetermined upper limit temperature condition.

At Step 704, the management device 50 outputs to the output device 70 data on the management code of an environmentally deviated article, the names of the two locations, the date and time of input of the management code or the like at each location, and an environmental condition (for example, temperature) surrounding the article obtained at Step 703.

As mentioned up to this point, the article quality management system according to this embodiment is capable of managing environmental conditions on distribution channels of articles and detecting any environmentally deviated article even when an identical management code is given to a plurality of articles.

### Second Embodiment

In relation to a second embodiment of the present invention, a description will be given to an article quality management system capable of detecting any forged article blended in articles on a distribution channel. The article quality management system according to this embodiment has a configuration similar to that of the article quality management system according to the first embodiment and makes it possible to implement detection of an environmentally deviated article described in relation to the first embodiment and detection of a forged article described in relation to this embodiment with a single system. However, in detection of a forged article described in relation to this embodiment, it is unnecessary to mark an environmental-responsive portion on each article and data related thereto need not be present.

In the article quality management system according to this embodiment, the management device 50 performs the same processing as the processing shown in FIG. 7 described in relation to the first embodiment. However, at Step 703 and Step 704, processing different from that in the first embodiment is performed. Hereafter, a description will be given to these steps. While in the first embodiment, at Step 701, the management device 50 receives an input of data on environmental conditions surrounding an article, in this embodiment, this data need not be inputted.

At Step 703, first, the management device 50 summarizes a number of pieces of the data shown in FIG. 6 by location and by management code. A result of the summarization may be organized in any way but organization, for example in such a format as shown in FIG. 8 will make the result easier to understand.

FIG. 8 is a table obtained by summarizing a number of pieces of the data shown in FIG. 6 by location and by management code. In the table in FIG. 8, locations are vertically arranged and management codes are horizontally arranged and individual cells indicate a number of pieces of data of each management code at each location. That is, a number of pieces of data indicated in each cell is equivalent to a number of pieces of data on a combination of a management code and a location corresponding to the cell and represents a number of articles of a management code corresponding to the cell distributed through a location corresponding to the cell (number of distributed articles). For articles of management code L1738, for example, the number of distributed articles thereof at location A is 1000 and the number of distributed articles thereof at location B is 500.

Subsequently, the management device 50 utilizes data summarized as shown in FIG. 8 and article distribution channel data shown in FIG. 3 (or FIG. 5) to search for a site of blending of the forged article by management code. In this search, a location at which the number of distributed articles is smaller than the sum of the numbers of distributed articles at all the adjacent downstream locations on the relevant distribution channels is taken as the site of blending. The management device 50 performs this search with respect to the combinations of all the locations and all the management codes (that is, with respect to all the pieces of data in FIG. 8). A more specific description will be given. The management device 50 compares a number of pieces of data for each combination of any one location and any one management code with a number of pieces of data having this management code at all the adjacent locations downstream of this location on each distribution channel and searches for a combination of a location and a management code in which the former number of pieces of data is smaller.

For example, it can be seen from FIG. 8 and FIG. 3 that the number of pieces of data is 1000 for the combination of location A and management code L1738 and the sum of numbers of pieces of data having management code L1738 at all the adjacent locations (location B and location C) downstream of location A on the relevant distribution channels is 900 (=500+400). Since the former number of pieces of data is larger (1000>900), the combination of location A and management code L1738 is not to be searched for. The number of pieces of data is 500 for the combination of location B and management code L1738 and the sum of numbers of pieces of data having management code L1738 at all the adjacent locations (location D and location E and location F) downstream of location B on the relevant distribution channels is 550 (=100+200+250). Since the former number of pieces of data is smaller (500<550), the combination of location B and management code L1738 is to be searched for.

Utilizing the searched combination of location and management code, the management device 50 determines that a forged article of an article having the searched management code (L1738) was blended into the articles on the distribution channels between the searched location (location B) and the adjacent locations (locations D, E, F) downstream of this location. This is based on the following principle: when a number of pieces of data is smaller on the upstream side than on the downstream side on a distribution channel of articles, that is, a number of pieces of data is increased on the downstream side, it indicates that an irregular distribution of articles, such as blending of a forged article, has occurred on that distribution channel.

According to this method, a forged article blended into articles on a distribution channel can be detected even when the management code of the forged article is not officially present or even when the management code of the forged article is identical with the management code of an authorized article.

At Step 704, the management device 50 outputs to the output device 70 a site at which a forged article is blended, all the adjacent locations downstream of the site of blending, the management code of an article for which a site of blending was searched for, and the like. The output device 70 displays these pieces of data. In the abovementioned example, among the names of the locations (locations B, D, E, F) and the management code (L1738) obtained at Step 703 and data shown in FIG. 6 inputted at each location, the management device 50 outputs data and the like related thereto to the output device 70.

As mentioned up to this point, the article quality management system according to this embodiment is capable of detecting a forged article blended into articles on a distribution channel and estimating a site, a time, and the like at which a forged article was blended into articles on a distribution channel.

### Third Embodiment

In relation to a third embodiment of the present invention, a description will be given to an article quality management system that enables a distribution channel of an article to be estimated. In the first embodiment and the second embodiment, article distribution channel data is predetermined and the management device 50 receives an input of given distribution channel data and utilizes the data (Step 702 in FIG. 7). However, when a distribution channel of an article is unknown, the management device 50 cannot utilize distribution channel data. To cope with this, in this embodiment, the management device 50 estimates a distribution channel of an article. The management device 50 can utilize a distribution channel of an article estimated in accordance with this embodiment and perform the processing described in relation to the first embodiment and the second embodiment.

In the article quality management system according to this embodiment, the management device 50 performs the same processing as that shown in FIG. 7 described in relation to the first embodiment but performs distribution channel estimation processing instead of the processing of Step 702. Other steps are identical with those in the first embodiment or the second embodiment and hereafter, a description will be given only to processing of estimating a distribution channel.

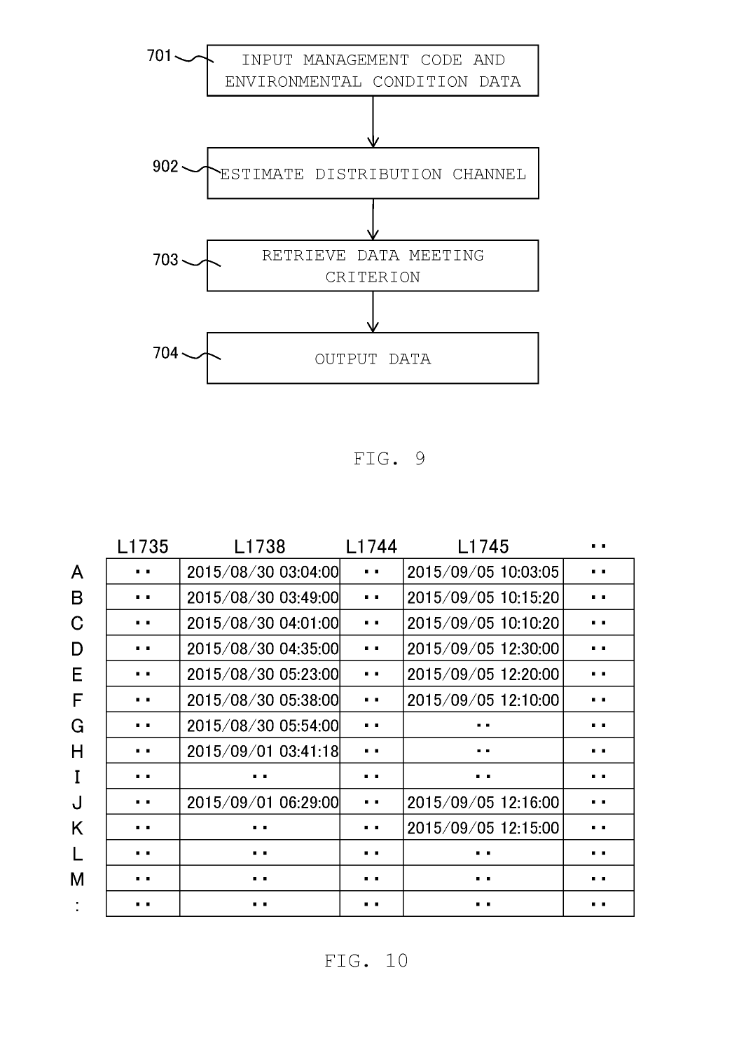

FIG. 9 illustrates steps of processing performed by the management device 50 in this embodiment. At Step 902, the management device 50 estimates a distribution channel of an article.

The principal of processing of estimating a distribution channel of an article utilizes the fact that: even when there are a plurality of articles of an identical management code, with respect to any one article, the date and time at which the management code thereof is initially inputted at each location are in the order of from the upstream to the downstream of each distribution channel without fail and never be in the order of from downstream to upstream. However, even when with respect to any one management code, locations are ordered in the order of the date and time at which the management code is initially inputted, this arrangement of locations not always represents a distribution channel of an article. This is because when there are a plurality of distribution channels running in parallel, these distribution channels cannot always be distinguished (separated). (An example will be taken. In FIG. 2, there are a distribution channel from location A to location B and a distribution channel from location A to location C. In this case, when locations A to C are ordered in the order of the date and time at which a management code is initially inputted, the resulting arrangement may be location A, location C, and location B but there is not a distribution channel running from location A to location B by way of location C.) Hereafter, a concrete description will be given to processing steps based on this principle.

At Step 902, first, with respect to all the combinations of a location and a management code, the management device 50 extracts date and time data inputted earliest from among the pieces of data shown in FIG. 6 and organizes the data in the format shown in FIG. 10.

FIG. 10 shows date and time data indicating the earliest date and time (that is, the date and time of input of data inputted earliest) with respect to all the combinations of a location and a management code shown in FIG. 6 in the form of table. In the table in FIG. 10, locations are vertically arranged and management codes are horizontally arranged and individual cells indicate the earliest date and time at which data on each management code was inputted at each location. From the data tabulated in FIG. 10, data (earliest data) for which the date and time of input are earliest can be grasped with respect to all the combinations of a management code and a site (location) of input of the management code. When there is not inputted data, the relevant cell is kept null.

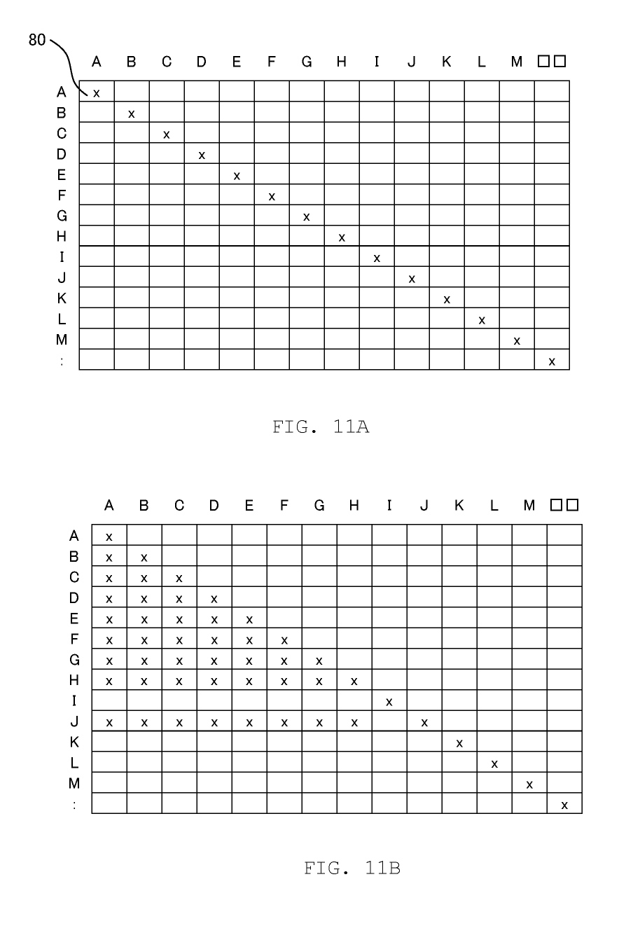

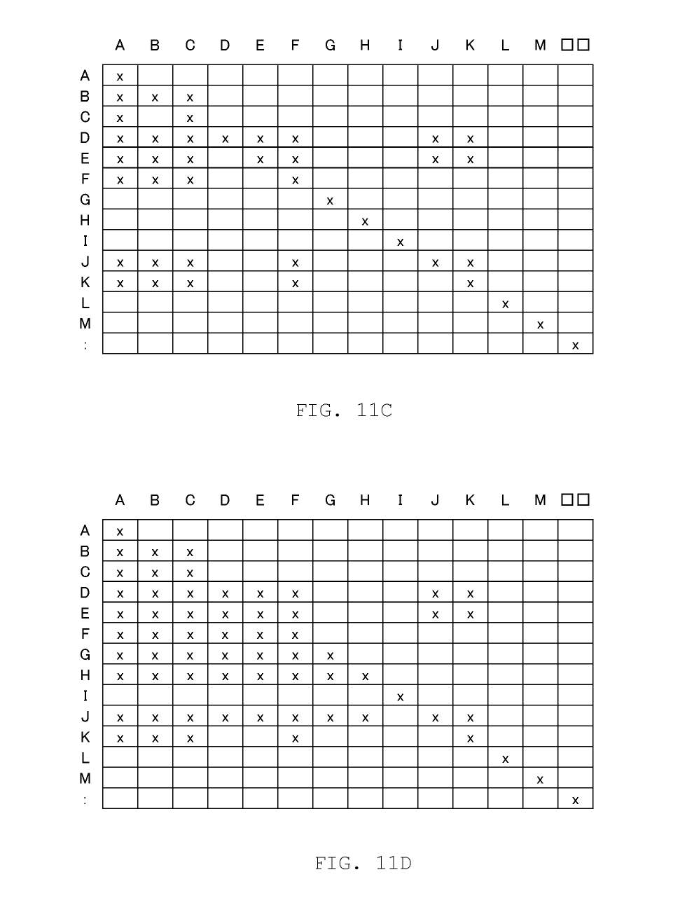

Subsequently, the management device 50 generates data in the form of table in which locations are arranged vertically and horizontally, like FIGS. 11A to 11D, from FIG. 10. Each cell in the tables in FIGS. 11A to 11D indicates the presence or absence of a possibility that a distribution channel running from a vertically arranged location to a horizontally arranged location. For example, the cell 80 in row B and column A indicates the presence or absence of a possibility that there is a distribution channel running from location B to location A. When there is not a distribution channel, “x” is filled in the cell; and when there is a possibility that a distribution channel is present, the cell is kept null.

FIG. 11A is a table in which locations are arranged vertically and horizontally and which indicates the presence or absence of a possibility that a distribution channel is present between two locations and is generated in the first phase in generating the data in FIG. 11D. In the first phase, “x” is filled in each cell indicating a distribution channel between identical locations. This is because there is not a distribution channel between identical locations, for example, a distribution channel from location A to location A or a distribution channel from location B to location B. The other cells than cells indicating a distribution channel between identical locations are kept null.

Subsequently, with respect to the null cells in FIG. 11A, the management device 50 examines whether a distribution channel is absent as described below and fills “x” in each cell indicating the absence of a distribution channel.

For example, to examine whether a distribution channel from location A to location B and a distribution channel from location B to location A are absent, the following processing is performed. With respect to each of all the management codes in the tabulated data shown in FIG. 10, a date and time corresponding to location A and a date and time corresponding to location B are compared with each other. When the date and time corresponding to location A is earlier than the date and time corresponding to location B, there is not a distribution channel running from location B toward location A; therefore, “x” is filled in the cell 80 in row B and column A corresponding to this distribution channel. That is, since it is impossible for the date and time at a location located on the downstream side of a distribution channel to be earlier than the date and time at a location located on the upstream side, it turns out that location A is located on the upstream side and location B is located on the downstream side. The abovementioned processing is performed on all the management codes in the tabulated data shown in FIG. 10.

In cases where a transportation time for articles between two locations is previously known when dates and times corresponding to the two locations are compared with each other, it is more desirable to take the following measure: when a difference between the compared dates and times is less than this transportation time, it is concluded that there is not a distribution channel between the two locations and “x” is recorded.

FIG. 11B is a table indicating a result of examination of whether there is a distribution channel between two locations with respect to articles of management code L1738. With respect to data about management code L1738 in the tabulated data shown in FIG. 10, the dates and times at two locations are compared with each other. Since there is not a distribution channel running from a location with a later date and time toward a location with an earlier date and time, “x” is filled in a cell corresponding to this distribution channel.

FIG. 11C is a table indicating a result of examination of whether there is a distribution channel between two locations with respect to articles of management code L1745. With respect to data about management code L1745 in the tabulated data shown in FIG. 10, the dates and times at two locations are compared with each other. Since there is not a distribution channel running from a location with a later date and time toward a location with an earlier date and time, “x” is filled in a cell corresponding to this distribution channel.

FIG. 11D is a table indicating a result of examination of whether there is a distribution channel between two locations with respect to articles of management code L1738 and articles of management code L1745. That is, FIG. 11D is a table obtained by superposing FIG. 11B and FIG. 11C on each other. In FIG. 11D, with respect to articles of management code L1738 and articles of management code L1745, “x” is not filled, for example, in the cell in row A and column B or the cell in row A and column C. Therefore, it can be seen that there is a possibility that a distribution channel running from location A toward location B and a distribution channel running from location A toward location C are present. In addition, “x” is not filled in the cell in row A and column D, row B and column D, or row C and column D. Therefore, it can be seen that among the distribution channels running toward location D, a distribution channel from location A, a distribution channel from location B, and a distribution channel from location C can be present. Further, “x” is filled in the cell in row C and column B and the cell in a row D and column J. Therefore, it can be seen that a distribution channel running from location C toward location B and a distribution channel running from location D toward location J are absent.

FIG. 11D shows results about articles in two groups of management code L1738 and management code L1745. In actuality, it is examined whether there is a distribution channel between two locations with respect to all the management codes in the tabulated data shown in FIG. 10. The following advantages are brought about by collecting data about articles of all the management codes and generating such a table as shown in FIG. 11D: possible distribution channels can be further narrowed down and this facilitates estimation of a distribution channel of an article. The management device 50 generates such a table as shown in FIG. 11D with respect to articles of all the management codes, estimates that there can be present a distribution channel going from a location indicating the row of a cell (null cell) with no “x” recorded toward a location indicating the column thereof, and determines this distribution channel as a candidate for a distribution channel of the relevant article.

Finally, with respect to each null cell in FIG. 11D, the management device 50 lists vertically arranged locations (locations represented by row) in the “from” column and lists horizontally arranged locations (locations represented by column) in the “to” column. Thus, such data on article distribution channels as shown in FIG. 3 (more precisely, data on candidates for article distribution channels) can be generated.

FIG. 13 is a table indicating the presence or absence of a distribution channel between two locations, generated from the table of article distribution channels shown in FIG. 3. In FIG. 13, “O” is filled in a cell indicating an existing distribution channel instead of filling “x” in a cell indicating a nonexistent distribution channel. FIG. 13 can be considered as a table corresponding to FIG. 11D. Pieces of data on articles of all the management codes are collected to generate such a table as shown in FIG. 11D. When in the obtained table, “x” is filled in all the cells with no “O” recorded in the table in FIG. 13, distribution channels of articles shown in FIG. 3 can be derived from the generated table. In reality, a table with “x” recorded in all the cells with no “O” recorded in the table in FIG. 13 cannot be always generated. However, by generating a table close to this table, possible distribution channels can be further narrowed down and estimation of an article distribution channel is further facilitated.

At Step 704 in FIG. 9, the management device 50 outputs to the output device 70 article distribution channels estimated at Step 902 (that is, candidates for article distribution channels obtained at Step 902). The output device 70 displays this data.

In this embodiment, it is possible to estimate an article distribution channel and obtain a candidate for a distribution channel as mentioned above. Utilization of the method for estimating an article distribution channel in accordance with this embodiment can implement the invention described in relation to the first embodiment and the second embodiment even when distribution channels are unknown beforehand. Candidates for distribution channels obtained by this method can include a channel that does not actually exist. However, to perform quality management, forged article search, or the like, manual check is indispensable in the final phase. Even though wrong candidates for distribution channels are more or less included, possible distribution channels can be narrowed down and this method is effective only for this reason.

The present invention is not limited to the abovementioned embodiments and can be variously modified. The above embodiments are intended to describe the present invention in detail to make the invention easier to understand. The present invention is not always limited to a mode in which the abovementioned constitution elements are all included. A configuration element of some embodiment may be partly replaced with a configuration element of another embodiment. A configuration element may be added to a configuration element of another embodiment. Some of the configuration elements of each embodiment may be deleted or replaced with another configuration element or another configuration element may be added thereto.

### LIST OF REFERENCE SIGNS

10, 11—Article
12—Two-dimensional barcode
13—One-dimensional barcode
21, 22, 23, 24, 25—Environmental-responsive portion
50—Management device
51—Data reception unit
52—Computation unit
53—Data storage unit
54—Data output unit
60—Input device
70—Output device
80—Cell in row B and column A

1. An article quality management system, comprising:
an input device receiving an input of data on management codes of a plurality of articles from the articles while in distribution;
a management device having a computation unit and a storage unit and receiving and recording data transmitted from the input device; and
an output device displaying data outputted by the management,
wherein the articles are classified into a plurality of groups according to the management codes and the articles belonging to an identical one of the groups are marked with an identical one of the management codes,
wherein the input device receives an input of data on the management codes at a plurality of sites through which the articles are distributed and transmits data on the management codes inputted and data on a date and time of input and a site of input of the data on the management codes to the management device,
wherein the management device:
obtains earliest data, which is data for which the date and time of input are earliest, with respect to all the combinations of the management codes and the sites of input in a plurality of pieces of data transmitted from the input device;
compares the date and time of input with the earliest data with respect to all the combinations of two different sites of input for each of all the management codes and performs distribution channel estimation processing based on the fact that there is not a distribution channel of the articles running from a site of input with the later date and time of input toward a site of input with the earlier date and time of input; and
obtains, among all the combinations of the two different sites of input, a combination other than the combinations for which it is determined by the estimation processing that there is not a distribution channel as a candidate for a distribution channel of the articles, and
wherein the output device displays the candidate for the distribution channel of the articles.

2. An article quality management system comprising:
an input device receiving an input of data on management codes of a plurality of articles from the articles while in distribution;
a management device having a computation unit and a storage unit and receiving and recording data transmitted form the input device; and
an output device displaying data outputted by the management device,
wherein the articles are classified into a plurality of groups according to the management codes and the articles belonging to an identical one of the groups are marked with an identical one of the management codes,
wherein the input device receives an input of data on the management codes at a plurality of sites through which the articles are distributed and transmits data on the management codes inputted and data on a date and time of input and a site of input of the data on the management codes to the management device,
wherein the management device:
receives an input of data on a predetermined distribution channel of the articles;
obtains, with respect to each of all the combinations of the management codes and the sites of input in a plurality of pieces of data transmitted from the input device, a number of distributed articles which is a number of pieces of data on the combinations; and
searches for a site of blending from among the sites of input with respect to each of the management codes, the site of blending being a site of input at which the number of distributed articles is smaller than the sum of the numbers of distributed articles at all the sites of input adjoining on the downstream side of the distribution channel, and
wherein the output device displays the site of blending, all the sites of input adjoining on the downstream side of the site of blending, and the management codes for which the site of blending is searched for.

3. The article quality management system according to claim 1,
wherein the management device:
obtains, with respect to each of all the combinations of the management codes and the sites of input in a plurality of pieces of data transmitted from the input device, a number of distributed articles which is a number of pieces of data on the combinations; and
searches for a site of blending from among the sites of input with respect to each of the management codes, the site of blending being a site of input at which the number of distributed articles is smaller than the sum of the numbers of distributed articles at all the sites of input adjoining on the downstream side on a candidate for the distribution channel, and
wherein the output device further displays the site of blending, all the sites of input adjoining on the downstream side of the site of blending, and the management codes for which the site of blending is searched for.

4. An article quality management system, comprising:
an input device receiving, from a plurality of articles while in distribution, an input of at least data on management codes of the articles for distinguishing the types of the articles and data on environmental conditions surrounding the articles;
a management device having a computation unit and a storage unit and receiving and recording data transmitted from the input device; and
an output device displaying data outputted by the management device,
wherein the articles are classified into a plurality of groups according to the management codes and the articles belonging to an identical one of the groups are marked with an identical one of the management codes,
wherein the articles are marked with an environmental-responsive portion indicating environmental conditions surrounding an article by a displayed color,
wherein the input device receives an input of data on the environmental conditions together with data on the management codes at a plurality of sites through which the articles are distributed and transmits data on the management codes inputted, data on the environmental conditions, and data on the dates and times of input and sites of input of data on the management codes to the management device,
wherein the management device:
receives an input of predetermined data on distribution channels of the articles varied depending on the distribution timing of the articles or the types of the articles;
searches for data satisfying a predetermined criterion from among data on the environmental conditions; and
using data on the management codes inputted together with the data on the environmental conditions, data on the dates and times of input and the sites of input of data on the management codes, and data on the distribution channels, obtains a first site which is the site of input at which the data satisfying the criterion is inputted and a second site which is the site of input adjoining to the first site on the upstream side on the distribution channels, and
wherein the output device displays the first site and the second site.

5.-8. (canceled)
